(19) United States
(12) Patent Application Publication
(10) Pub. No.: US 2014/0374390 A1
(43) Pub. Date: Dec. 25, 2014

(54) High production laser cutting automated system

(71) Applicants: Michael Beransky, Irvine, CA (US); Joseph R. Greeninger, Irvine, CA (US)

(72) Inventors: Michael Beransky, Irvine, CA (US); Joseph R. Greeninger, Irvine, CA (US)

(21) Appl. No.: 13/987,002

(22) Filed: Jun. 24, 2013

(51) Int. Cl. B23K 26/08

(52) U.S. Cl. CPC B23K 26/0838
USPC 219/121.7

(57) ABSTRACT

A laser cutting system wherein a conveyor system indexes sheet material through various processing stations, the processing stations operating simultaneously during the time period when the conveyor is stopped.

### BACKGROUND OF THE INVENTION

1. Field of the Invention

The present invention provides a complete system to load, process (cut) sort and stack a variety of sheet metal parts, the cutting process being performed by a high speed laser.

2. Description of the Prior Art

Sheet metal products are typically formed in a piece of sheet metal and connected to the sheet metal through one or more micro-joints. In order to separate these parts, it is conventional that subsequent mechanical or manual hammering or vibrating is carried out with respect to the sheet metal.

The use of a moving table to transport sheet metal is a highly effective system when the laser unit operates at a slower pace. However, for faster laser units which require processing complete sheets in less than two minutes, the conventional moving table systems have been found to be inefficient. When the total load, cut, unload and sort process for a metal sheet is to be completed in two minutes or less, a high speed conveying system is required.

U.S. Pat. No. 8,253,064 to Beck et al discloses a laser blanking device for high speed cutting of material that uses synchronized laser cutting operations along multiple axes and on a continuously moving coil strip.

The coil strip is moved through the device at a velocity substantially equal to the velocity of the moving pin conveyor.

The system is designed to increase production rates by minimizing stationary periods; this is accomplished by increasing the speed of the cutting operation of rapidly fed coil stock (a “coil” of material weights between 5,000 and 40,000 pounds; changing between material types will take between 20-40 minutes). The problem with this is the inability to change material type and thickness quickly enough to keep up with a “high mix low volume” environment.

A fiber laser cutting system (designated the FOL-AJ) for cutting material has been developed by Amada America, Inc., Buena Park, Calif. and is designed to take full advantage of the unique cutting capabilities of fiber laser processing. The advanced motion system and an innovative beam delivery system keeps pace with the cutting speeds and capabilities of the fiber resonator. The result is an extremely productive fiber laser system that delivers speed, accuracy, and edge quality, even in thick sheets.

Fiber technology does not require any laser gas in order to generate the laser beam, thereby reducing environmentally harmful emissions. Additionally, the FOL-AJ consumes approximately ⅓ the amount of energy required by a 4 kW CO₂ laser and about ¼ the amount compared to a 6 kW CO₂ laser. The system's resonator generates a laser beam with a wavelength (1.08 μm) that is approximately a tenth of that produced by a conventional gas laser. The 1.08 μm wavelength expands processing capabilities to include materials that were previously difficult or impossible to cut with CO₂ lasers. The FOL-AJ also delivers increases in speeds, up to (and beyond) 4 times faster that its CO₂ counterparts in thin materials.

The motion system of the FOL-AJ includes linear drive motors in all 3 axes. This provides for over 13,300 ipm in traverse speeds and 5 G acceleration over the entire work envelope material delivered to the FOL-AJ.

Although moving tables have been successfully utilized in the cutting operation noted hereinabove, there are inherent limitations in their use with high speed laser systems, such as the FOL-AJ. Specifically, Amada is currently marketing a FOL-AJ based system using a plurality of moving tables to convey material to the laser cutter. In this system, the movable table is loaded with material, the table traveling into/out of the laser device for each cycle. The empty moving table is loaded with the new material while the laser is processing the previously loaded material. After a moving table delivers the loaded material to the laser, and the material exits the laser, a different moving table is loaded with new material (a robot first unloads the cut parts before new material can be loaded onto a moving table). In addition, scraps must be unloaded before new material is loaded onto a moving table. Although this system performs extremely well, the use of moving tables in the process limits the processing speeds and, as a result, the processing times are less than desired for certain applications

The systems disclosed in the '064 patent and the FOL-AJ system as noted hereinabove are also limited because of their inability to change sheet material type and thickness rapidly as is required in current system applications (as noted hereinabove, the '064 system takes between 20 and 40 minutes to change material; the FOL-AJ system takes approximately 2 minutes to change material). In addition, part separations by gravity used in the '064 system is limited to simple part geometrics (i.e. round, rectangular and square) because more complex geometries will hang up in the skeleton and not drop correctly.

What is thus desired is to provide a material conveyor system adapted for use in fiber laser processing systems which overcome the disadvantage of using the prior art systems as noted hereinabove.

### SUMMARY OF THE INVENTION

The present invention provides an automated system for handling material and parts and scrap cut therefrom.

The system uses a conveyor for the material, the conveyor moving sheet material into the laser for cutting purposes. The empty conveyor space is loaded with new material as the laser is processing the previously loaded sheet of material. The conveyor is indexed one position such that new sheet material is loaded into the laser as processed material is moved from the laser to the part unloading station, both processes occurring at the same time.

A robot then unloads the parts from the processed sheet material while new sheet material is being loaded on the side of the conveyor opposite where the laser is positioned. The conveyor is further indexed and scrap is automatically unloaded, all the processes occurring simultaneously.

The conveyor features noted hereinabove significantly decreases the system processing time compared to systems using moving (shuttle) tables and is particularly adaptable for use with high speed lasers, such as the FOL-AJ system noted hereinabove.

The sheet metal material is precut to specific lengths, allowing many types and thicknesses of material to be loaded and processed on a sheet by sheet basis. Parts are picked up by a robot and stacked in preparation for the next process (bending, welding, etc.). Scrap is destructed during the last process and is automatically dumped into a scrap box as the conveyor indexes.

A material storage tower with a sheet by sheet loading process is provided. The conveyor comprises a plurality of blades with brushes for blade cleaning and a anti-spatter device to prevent the parts from welding to the blades.

### DESCRIPTION OF THE DRAWINGS

For a better understanding of the present invention as well as other objects and further features thereof, reference is made to the following description which is to be read in conjunction with the accompanying drawing wherein:

FIGS. 1-2 illustrate a prior art laser cutting system;

FIGS. 3-9 are simplified representations of the steps necessary for rapidly loading/unloading sheet material onto the conveyor in accordance with the teachings of the present invention; and

FIG. 10 is a depiction of the overall system of the present invention.

### DESCRIPTION OF THE INVENTION

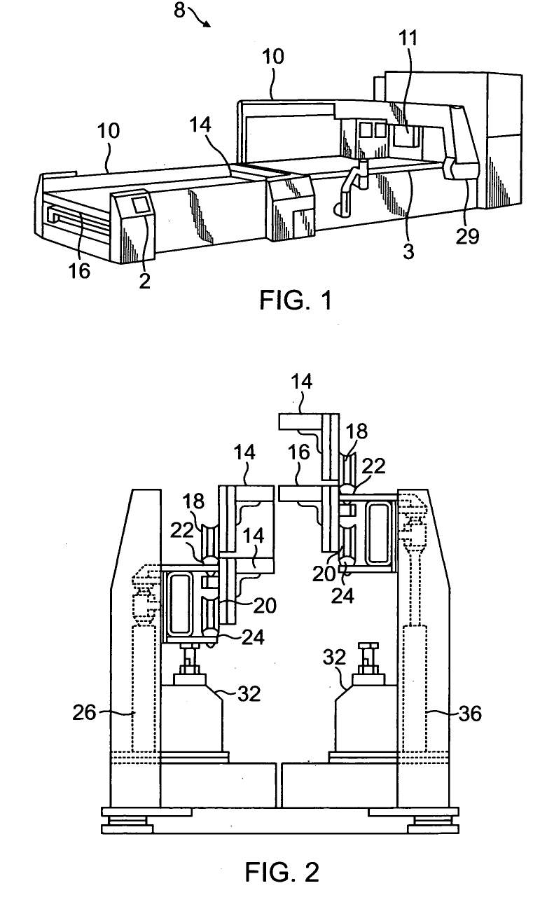

FIGS. 1 and 2 illustrates a prior art system for handling material and parts cut therefrom utilizing movable tables, such as shuttles. In FIG. 1, Index B comprises a laser cutting device 11, shuttle table 12, upper shuttle cart 14, lower shuttle cart 16, cart wheels 18 and 20, tracks 22 and 24, and cylinders 26 and 28. Cylinders 26 and 28 operate to raise and lower shuttle carts 14 and 16 in a predetermined sequence such that the carts can be aligned with the tracks associated with laser cutting device 11. In essence, the shuttle carts 14 and 16 are used to both transport sheet material to the laser unit and remove the sheet material after parts are cut therein.

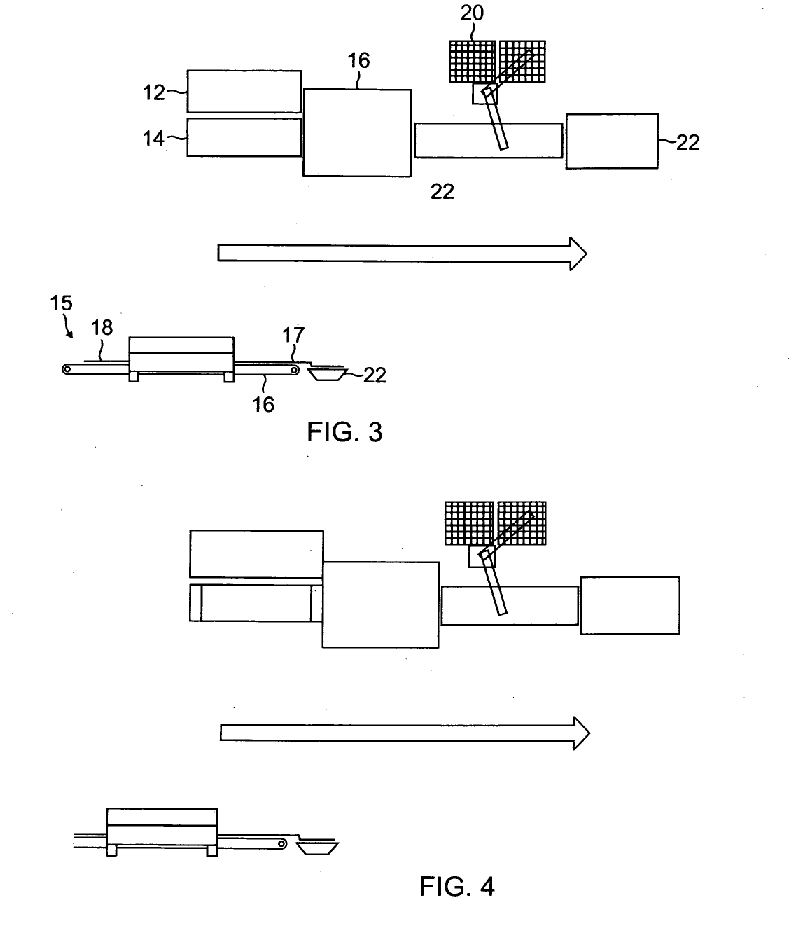

FIGS. 3-8 illustrate the process steps utilized to cut parts in sheet material by the cutting system 10 using the conveyor of the present invention.

FIG. 3 illustrates the first step of the process of the present invention and the components associated therewith.

A conventional tower 50 is utilized to store material sheets 52 from which parts will be cut in accordance with the programming commands of a microcontroller (not illustrated). Material sheets 52 are delivered, in sequence, by the tower 50 to a first end portion 54 of the conveyor system 56. Conveyor system 56 moves material sheets 52 to a high speed laser cutting system 58, such as the Amada laser FOL-AJ. System 58 cuts parts from each material sheet 52 into desired shapes and destroys the material skeleton, the parts being removed from conveyor portion 55 via robot system 60 and the remaining destroyed material (skeleton) being unloaded into a scrap receptacle 62. Note that a computer software program is provided to control the parts creation and scrap destruction. The tower 50 provides the user with the opportunity to load the tower with different metals of various shapes and sizes which are then processed.

FIG. 4 represents the stage of the process wherein the material sheets 52 are cut by laser system 58. The specific shaper of each part is determined by a controller (not shown) programmed to control laser system 58 to produce the desired parts. The processing steps are completed simultaneously during the short time period when the conveyor stops.

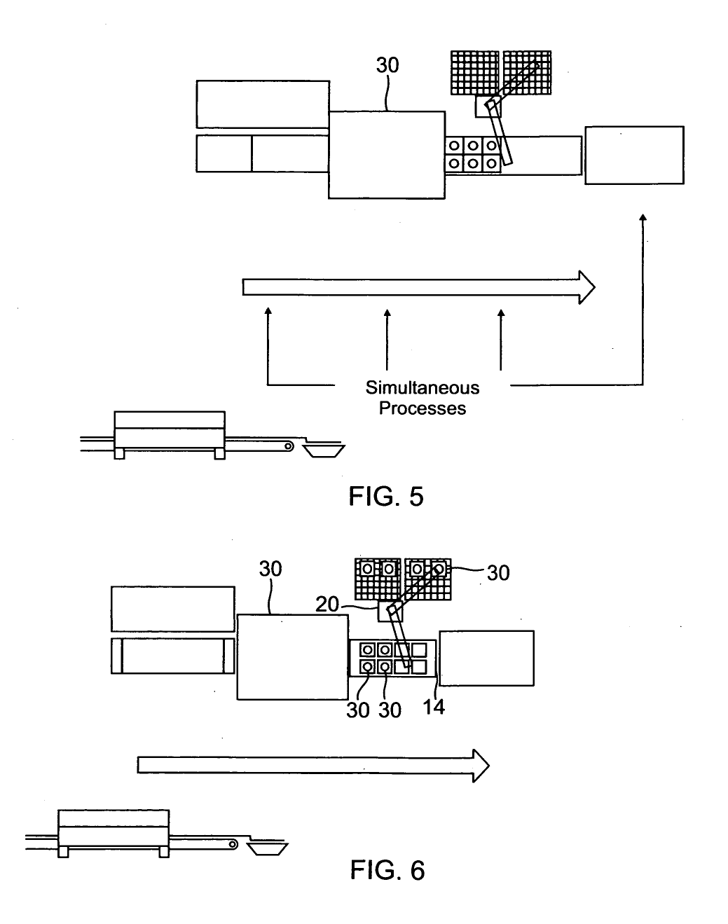

FIG. 5 illustrates cut parts 70 from material sheet 52 that have been cut as material sheet 52 exits from the laser cutting station 58.

FIG. 6 illustrates the transfer of selected parts 70 from the conveyor 56 to storage area 72 using robot system 60 (four completed parts are shown stored in area 72).

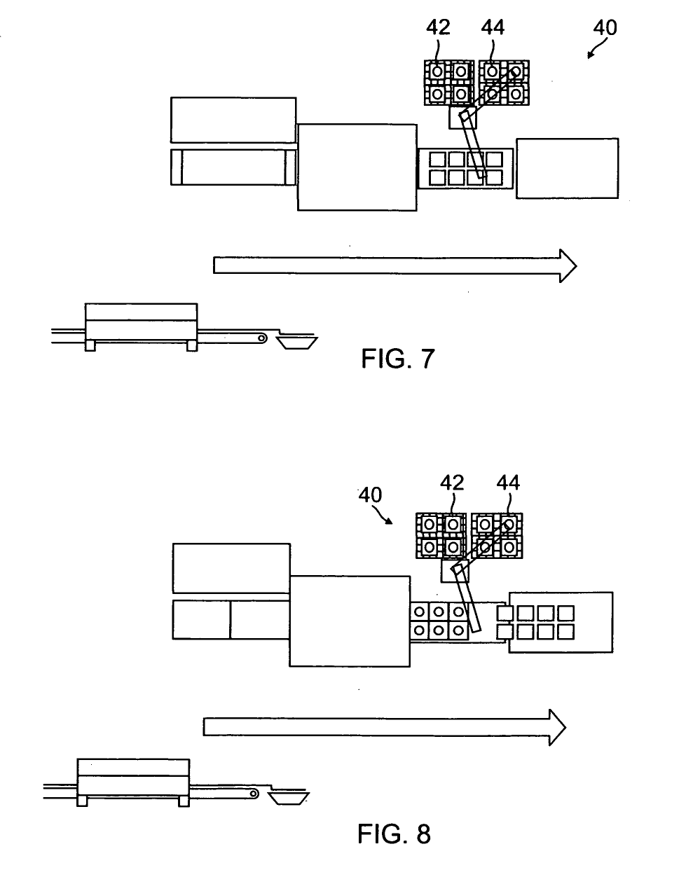

FIG. 7 shows the cut parts 30 that have been removed from sheets 52 and moved to two storage units 74 and 76 and sorted into their spaces in storage cells in their respective units. Note that some parts can be removed manually if the need arises.

FIG. 8 illustrates the scrap 78 being removed from conveyor 56 and deposited in scrap receptacle 62.

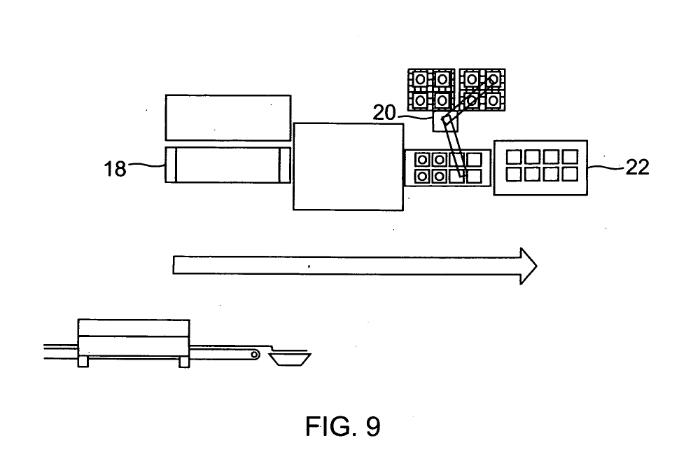

FIG. 9 illustrates a new material sheet 52 loaded onto conveyor system 56 at the same time that the scrap is being moved into scrap receptacle 62.

As conveyor system 56 “indexes” one position, a new material sheet 52 is loaded into laser system 58 and then processed; the processed material sheet then exits the laser system 58 to the part unloading system, all at the same time.

Tower 50, laser system 58 and robot 60 all operate simultaneously each time the conveyor system 56 indexes.

The material sheet 52 is precut to a specific length allowing many different material types and thicknesses to be loaded and processed on a sheet by sheet basis. The tower 50 loads single sheets of material on conveyor system portion 54, the conveyor system 56 preferably comprising a system of blades mounted to a belt type member that moves in an endless loop and utilizes brushes for blade cleaning and an anti-spatter spring device to prevent the parts from welding to the blades. Robot 60 picks up the cut parts and stacks them according to size, shape, etc.

As noted hereinabove, the scrap skeleton is destroyed during the laser cutting process and the debris resulting therefrom is automatically moved into the scrap box 62 as the conveyor is indexed.

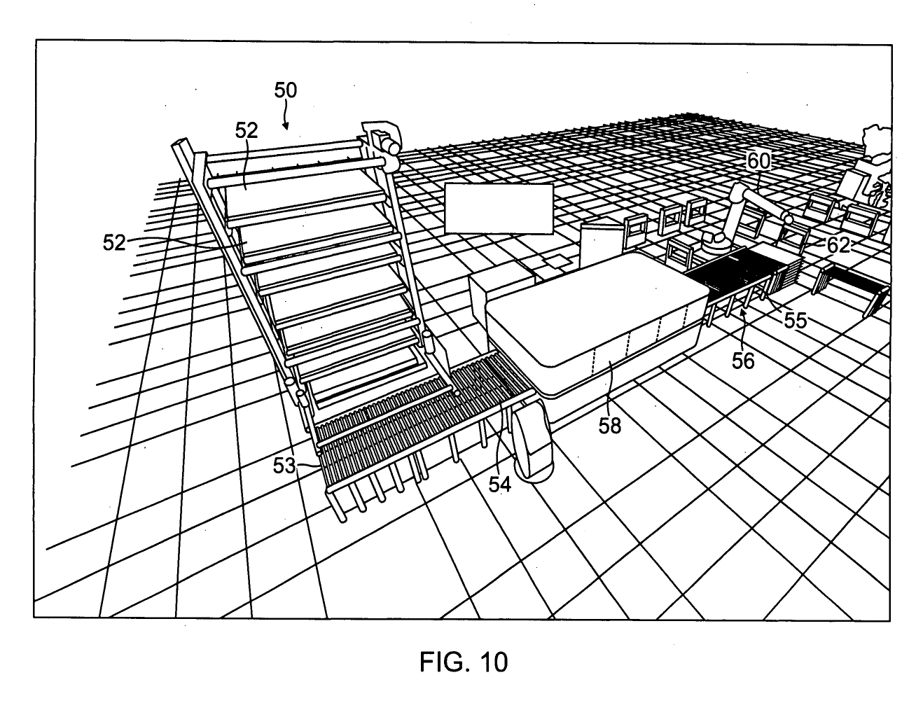

FIG. 10 is a depiction of the system in which the conveyor system of the present invention is to be utilized.

A storage tower 50 is stacked with the selected material sheets 52 and delivers the sheets via platform 53 to conveyor system portion 56. As the conveyor system 56 is indexed, the selected material sheets are moved to laser cutting system 58 wherein parts are cut into the material sheet 52 being processed, the shape of the cut part being determined by the microprocessor controlling laser cutting system 58. The cut parts are then delivered to conveyor system portion 55 which transports the parts to an area adjacent robot system 60, the robot system removing the cut parts and storing them to receptacle 62.

The use of a conveyor system instead of conventional movable tables for handling sheet material enables the four processes (load, cutting, unload, and scrap removal) to be done simultaneously and continually at very rapid speeds (a single sheet of material can be processed in approximately thirty seconds).

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A laser cutting system for rapidly moving sheet material through a plurality of processing stations comprising:
a material storage device for storing a first sheet having a first thickness and shape and a second sheet having a second thickness;
a conveyor system having first, second and third processing stations;
means for loading sheet material on said conveyor at said first location;
means for enabling said conveyor system to move in a horizontal direction towards said second location, said movement comprising a series of sequential steps;
a laser cutting station at said second location whereby parts are formed in said material sheet; and
a part unloading station at said third location whereby said parts are removed from said material sheet as it exits said laser cutting station.

2. The system of claim 1 further including a fourth station positioned downstream from said third location for collecting the material remaining after said parts are removed.

3. The system of claim 2 wherein said first sheet material has a thickness and shape different from said second sheet material.

4. The system of claim 1 wherein said laser cutting station includes a high speed laser.

5. The system of claim 1 wherein said conveyor system is indexed through said first, second and third processing stations.

6. The system of claim 5 wherein said conveyor system comprises a belt type member that moves in an endless loop.
